(19) United States
(12) Patent Application Publication
(10) Pub. No.: US 2007/0183303 A1
(43) Pub. Date: Aug. 9, 2007

(54) Method and apparatus for specifying channel state information for multiple carriers

(76) Inventors: Zhouyue Pi, San Diego, CA (US); Fei Frank Zhou, San Diego, CA (US); Zhigang Rong, San Diego, CA (US); Lin Ma, San Diego, CA (US)

Correspondence Address: DITTHAVONG & MORI, P.C., Suite A, 10507 Braddock Road, Fairfax, VA, 22032, US

(21) Appl. No.: 11/442,639

(22) Filed: May 26, 2006

Related U.S. Application Data
(60) Provisional application No. 60/684,856, filed on May 26, 2005.

(51) Int. Cl. H04J 11/00

(52) U.S. Cl. 370/206

(57) ABSTRACT

An approach is provided for specifying channel state information in a multi-carrier communication system. A determination of either spectral locations of a first carrier and a second carrier, or correlation between the first carrier and the second carrier is made. A report format among a plurality of report formats is selected based on either the determined correlation or spectral locations. Each of the report formats specifies channel state information for the first carrier and the second carrier. The channel state information includes data rate information.

### RELATED APPLICATIONS

This application claims the benefit of the earlier filing date under 35 U.S.C. §119(e) of U.S. Provisional Application Ser. No. 60/684,856 filed May 26, 2005, entitled “Method and Apparatus for Specifying Data Rate Information in a Multi-carrier Communication System,” the entirety of which is incorporated by reference.

### FIELD OF THE INVENTION

Various exemplary embodiments of the invention relate generally to communications, and more particularly to providing signaling in a multi-carrier system.

### BACKGROUND OF THE INVENTION

Radio communication systems, such as cellular systems (e.g., spread spectrum systems (such as Code Division Multiple Access (CDMA) networks), and Time Division Multiple Access (TDMA) networks), provide users with the convenience of mobility along with a rich set of services and features. This convenience has spawned significant adoption by an ever growing number of consumers as an accepted mode of communication for business and personal uses in terms of communicating voice and data (including textual and graphical information). As a result, cellular service providers are continually challenged to enhance their networks and services. These objectives place a premium on efficient management of network capacity.

The development of multi-carriers systems stem, in part, from the recognition that greater data rates are required to support sophisticated applications, and the general need for better system performance. One area of interest is the signaling required to indicate the desired data rate for establishing communication between the network and a terminal. This data rate negotiations process is particularly challenging in a multi-carrier environment that supports a multitude of services and applications (exhibiting a range of data rates, delay tolerances, etc.), as the network has to coordinate the optimal use of the carriers, while minimizing signaling overhead.

There is a need for an approach for conveying the data rate information in a multi-carrier system that minimizes signaling overhead.

### SUMMARY OF SOME EXEMPLARY EMBODIMENTS

These and other needs are addressed by various exemplary embodiments of the invention, in which an approach is presented for providing different formats of channel state information based on correlation or spectral location of the carriers. This approach advantageously assists the network with allocating resource more efficiently, thus resulting in better system performance.

According to one aspect of an embodiment of the invention, a method comprises determining either spectral locations of a first carrier and a second carrier, or correlation between the first carrier and the second carrier. The method also comprises selecting a report format among a plurality of report formats based on either the determined correlation or spectral locations. Each of the report formats specifies channel state information for the first carrier and the second carrier. The channel state information includes data rate information.

According to another aspect of an embodiment of the invention, an apparatus comprises a processor configured to determine either spectral locations of a first carrier and a second carrier, or correlation between the first carrier and the second carrier. The apparatus also comprises selection logic configured to select a report format among a plurality of report formats based on either the determined correlation or spectral locations. Each of the report formats specifies channel state information for the first carrier and the second carrier. The channel state information includes data rate information.

According to yet another aspect of an embodiment of the invention, a system comprises a base station configured to communicate over a first link comprising a plurality of carriers. The system also comprises a terminal configured to communicate with the base station over the first link and a second link, wherein the terminal is further configured to determine either spectral locations of the carriers or correlation between the carriers. The terminal is further configured to select one of a plurality of report channel formats corresponding to the second link based on either the spectral locations or the correlation. Each of the report channel formats specifies channel state information including data rate information for the carriers.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The invention is illustrated by way of example, and not by way of limitation, in the figures of the accompanying drawings in which like reference numerals refer to similar elements and in which:

FIG. 1 is a diagram of the architecture of a multi-carrier system configured to provide signaling for channel state information including data rate information, in accordance with an embodiment of the invention;

FIG. 2 is a diagram showing components for providing channel state information in the system of FIG. 1, according to various embodiments of the invention;

FIG. 3 is a flowchart of a process for determining report format based on correlation of multiple carriers, in accordance with an embodiment of the invention;

FIG. 4 is a flowchart of a process for determining report format based on spectral location of the carriers, in accordance with an embodiment of the invention;

FIGS. 5A and 5B are flowcharts, respectively, of a process for coding reports relating to channel state information, and a process for negotiating a new report format (or structure of a feedback channel), according to various embodiments of the invention;

FIG. 6 is a diagram of hardware that can be used to implement various embodiments of the invention;

FIGS. 7A and 7B are diagrams of different cellular mobile phone systems capable of supporting various embodiments of the invention;

FIG. 8 is a diagram of exemplary components of a mobile station capable of operating in the systems of FIGS. 7A and 7B, according to an embodiment of the invention; and

FIG. 9 is a diagram of an enterprise network capable of supporting the processes described herein, according to an embodiment of the invention.

### DESCRIPTION OF THE PREFERRED EMBODIMENT

An apparatus, method, and software for signaling channel state information in a multi-carrier communication system are described. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although the invention is discussed with respect to a radio communication network (such as a cellular system), it is recognized by one of ordinary skill in the art that the invention has applicability to any type of communication systems with multi-carrier or multi-channel capability (e.g., Time Division Multiplexing (TDM) and Code Division Multiplexing (CDM) systems). Additionally, although various embodiments of the invention are described in the context of data rate control (DRC) channel of a three carrier system, these embodiments can be extended to other multi-carrier systems and other channel quality related information, e.g., channel quality indicator (CQI). Further, the signaling mechanism is described with respect to multiple carriers on the forward link, it is contemplated that this mechanism can be applied to multiple carriers on the reverse link (whereby the feedback information is transported over the forward link).

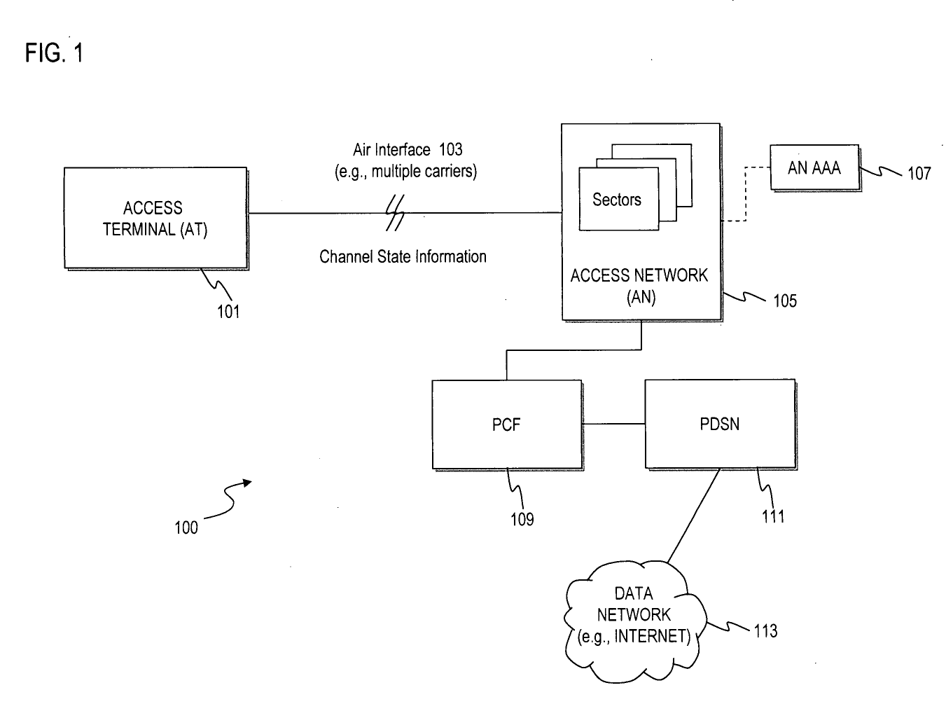

FIG. 1 is a diagram of the architecture of a multi-carrier system configured to provide signaling for channel state information including data rate information, in accordance with an embodiment of the invention. The radio network 100 includes one or more access terminals (ATs) 101 of which one AT 101 is shown in communication with an access network (AN) 105 over an air interface 103. The system 100, according to one embodiment, provides Third Generation Partnership Project 2 (3GPP2) cdma2000 High Rate Packet Data Revision C (also known as cdma2000 Evolution Phase 2, DO Revision C) networks. In another embodiment, the system 100 also supports 3GPP Long Term Evolution (LTE) systems. In cdma2000 systems, the AT 101 is equivalent to a mobile station, and the access network 105 is equivalent to a base station.

For the purposes of illustration, the system 100 operates as a Nx DO system (where N is an integer). In a Nx DO system, the reverse link needs to feed back channel state information—e.g., Data Rate Control (DRC) information—for the N forward link 1x carriers. The Data Rate Control information, for example, specifies the forward link data rate that an AT can receive in a 1x carrier; in such a 1xDO system, the Data Rate Control values are specified using 4 bits. Thus, for a 3x DO system, 12 bits may be needed; this is a significant increase in overhead. The various embodiments of the invention, however, minimize overhead by exploiting redundancy inherent in the data rate control information for the multiple carriers. In one embodiment, the system 100 can be implemented as an overlay N 1x network.

The AT 101 is a device that provides data connectivity to a user. For example, the AT 101 can be connected to a computing system, such as a personal computer, a personal digital assistant, and etc. or a data service enabled cellular handset. The radio configuration encompasses two modes of operations: 1x and multi-carrier (i.e., Nx). Multi-carrier systems employ multiple 1x carriers to increase the data rate to the AT 101 (or mobile station) over the forward link. Hence, unlike 1x technology, the multi-carrier system operates over multiple carriers. In other words, the AT 101 is able to access multiple carriers simultaneously. Additionally, the reverse link can utilize multiple carriers.

The AN 105 is a network equipment that provides data connectivity between a packet switched data network, such as the global Internet 113 and the AT 101. The AN 105 communicates with a Packet Data Service Node (PDSN) 111 via a Packet Control Function (PCF) 109. Either the AN 105 or the PCF 109 provides a SC/MM (Session Control and Mobility Management) function, which among other functions includes storing of HRPD session related information, performing the terminal authentication procedure to determine whether an AT 101 should be authenticated when the AT 101 is accessing the radio network, and managing the location of the AT 101. The PCF 109 is further described in 3GPP2 A.S0001-A v2.0, entitled “3GPP2 Access Network Interfaces Interoperability Specification,” June 2001, which is incorporated herein by reference in its entirety.

In addition, the AN 105 communicates with an AN-AAA (Authentication, Authorization and Accounting entity) 107, which provides terminal authentication and authorization functions for the AN 105.

Both the cdma2000 1xEV-DV (Evolution-Data and Voice) and 1xEV-DO (Evolution-Data Optimized) air interface standards specify a packet data channel for use in transporting packets of data over the air interface on the forward link and the reverse link. The wireless communication system 100 may be designed to provide various types of services. These services may include point-to-point services, or dedicated services such as voice and packet data, whereby data is transmitted from a transmission source (e.g., a base station) to a specific recipient terminal. Such services may also include point-to-multipoint (i.e., multicast) services, or broadcast services, whereby data is transmitted from a transmission source to a number of recipient terminals (e.g., AT 101).

In the multiple-access wireless communication system 100, communications between users are conducted through one or more AT(s) 101 and a user (access terminal) on one wireless station communicates to a second user on a second wireless station by conveying information signal on a reverse link to a base station. The AN 105 receives the information signal and conveys the information signal on a forward link to the AT station 101. The AN 105 then conveys the information signal on a forward link to the station 101. The forward link refers to transmissions from an AN 105 to a wireless station 101, and the reverse link refers to transmissions from the station 101 to the AN 105. The AN 105 receives the data from the first user on the wireless station on a reverse link, and routes the data through a public switched telephone network (PSTN) to the second user on a landline station. In many communication systems, e.g., IS-95, Wideband CDMA (WCDMA), and IS-2000, the forward link and the reverse link are allocated separate frequencies.

The AN 105, in an exemplary embodiment, includes a High Rate Packet Data (HRPD) base station to support high data rate services. It should be understood that the base station provides the radio frequency (RF) interface (carrier(s)) between an access terminal and the network via one or more transceivers. The HRPD base station provides a separate data only (DO) carrier for HRPD applications for each sector (or cell) served by the IHRPD base station. A separate base station or carrier (not shown) provides the voice carrier(s) for voice applications. A HRPD access terminal may be a DO access terminal or a dual mode mobile terminal capable of utilizing both voice services and data services. To engage in a data session, the HRPD access terminal connects to a DO carrier to use the DO high-speed data service. The data session is controlled by a Packet Data Service Node (PDSN) 111, which routes all data packets between the HRPD access terminal and the Internet. The PDSN 111 has a direct connection to the Packet Control Function (PCF) 109, which interfaces with a Base Station Controller (BSC) of the HRPD base station. The BSC is responsible for operation, maintenance and administration of the HRPD base station, speech coding, rate adaptation and handling of the radio resources. It should be understood that the BSC may be a separate node or may be co-located with one or more HRPD base stations.

In a 1x carrier, each HRPD base station can serve multiple (e.g., three) sectors (or cells). However, it should be understood that each HRPD base station may generally serve only a single cell (referred to as an omni cell). It should also be understood that the network 100 may include multiple HRPD base stations, each serving one or more sectors, with HRPD mobile terminals being capable of handing off between sectors of the same HRPD base station or sectors of different HRPD base stations. For each sector (or cell), the HRPD base station further employs a single shared, time division multiplexed (TDM) forward link, where one single HRPD mobile terminal can be served by single user packets and multiple mobile terminals can be served by multi-user packets at any instance. The forward link throughput rate is shared by all HRPD mobile terminals. A HRPD access terminal selects a serving sector (or cell) of the HRPD base station by pointing its Data Rate Control (DRC) towards the sector and requesting a forward data rate according to the channel conditions (i.e., based on the Carrier to Interference (C/I) ratio of the channel).

Wireless communication technologies continue to evolve to provide higher data rate and better quality of service for a variety of applications with distinct characteristics. The cdma2000 High Rate Packet Data (HRPD) standard provides high data rate over, for example, a 1.25 MHz carrier frequency. This system provides Data Only (DO) service in one 1.25 MHz carrier (1x), which sometimes is referred to as 1x DO system. To further improve the service provisioning, this cdma2000 HRPD standard needs to account for multi-carrier CDMA systems. In this system (referred to as multi-carrier HRPD (MC-HRPD) system, or Nx DO system), the access terminal (AT) 101 can transmit and/or receive data streams in multiple 1.25 MHz bands. Particularly, one network configuration is to support communication over three 1.25 MHz bands (e.g., a 3x DO system). By way of example, the system 100 is a 3x DO system, which can be used to overlay with a legacy HRPD system that operates within one 1.25 MHz band. This approach advantageously provides reuse of many technologies and components in 1x DO systems, thereby reducing the development cost, and providing a smooth transition from 1x DO to multi-carrier systems, such as 3x DO.

Further evolution of cdma2000 HRPD systems employ advanced communication technologies such as Orthogonal Frequency Division Multiplexing (OFDM), Multiple-Input-Multiple-Output (MIMO) technologies, Spatial Division Multiple Access (SDMA), and interference cancellation. These systems can operate in 1.25 MHz ˜20MHz spectrum. One approach for accommodating a multitude of ATs in a multi-carrier operation is explained in 3GPP2 contribution, C25-20050620-030, entitled “Increased Forward Link MAC Indices For Multi-Carrier Operation,” Jun. 20, 2005 (which is incorporated herein by reference in its entirety).

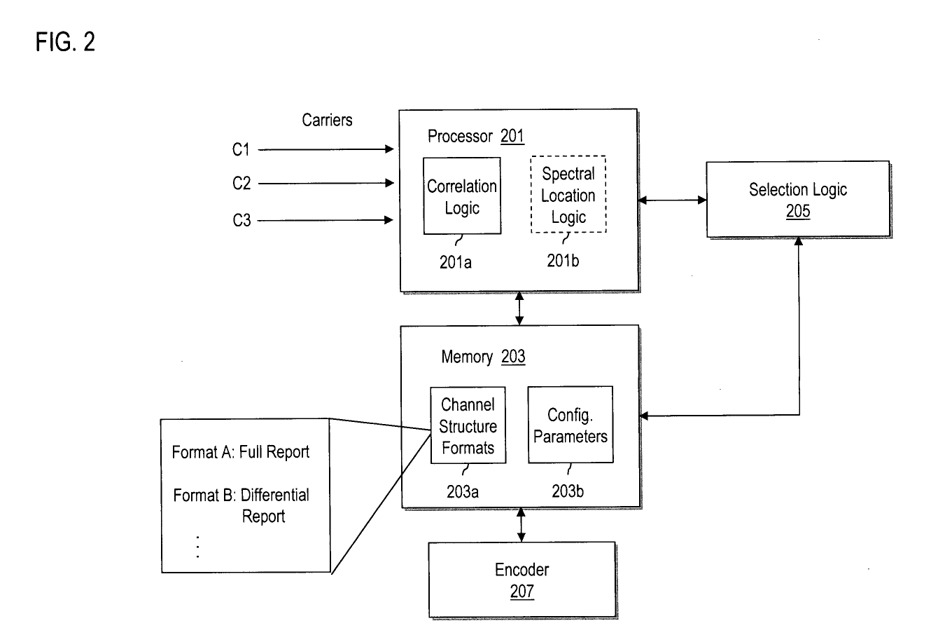

FIG. 2 is a diagram showing components for providing channel state information in the system of FIG. 1, according to various embodiments of the invention. It is recognized that if the N (e.g., three) 1x carriers are within the same coherence bandwidth (e.g., 5 MHz band), the channel state information (e.g., DRC information) for these carriers is highly correlated. Consequently, overhead in the reverse link can be minimized by exploiting such correlation. Continuing with the exemplary 3xDO system, the three 1x carriers can be referred to as C1, C2, and C3. The DRC's for these three carriers are denoted as DRC1, DRC2, and DRC3, respectively. In the wireless communication system 100, some ATs (e.g., AT 101) may experience flat fading because the carrier bandwidth is smaller than the coherence bandwidth dictated by the environment surrounding the ATs. Other ATs may experience frequency selective fading because the carrier bandwidth is larger than the coherence bandwidth dictated by the environment surrounding those ATs. If C1, C2, and C3 are within a coherence bandwidth for the AT 101, the channel conditions in these carriers may be highly correlated. Hence, DRC1, DRC2, and DRC3 contain some redundancy.

Thus, instead of transmitting all three full DRC's to the AN 105, the AT 101 can take advantage of the redundancy and transmit fewer bits, while achieving nearly the same utility as three full DRC's. On the other hand, if the distance between C1, C2, and C3 are much larger than the coherence bandwidth for another AT, the correlation among these carriers is small. In this case, it may warrant reporting three full DRC's for that AT.

As seen in FIG. 2, a processor 201 receives information about the carriers, C1, C2 and C3, and includes correlation logic 201a (i.e., correlator) to determine the correlation of these carriers. Alternatively, the processor 201 can implement a spectral location logic 201b to determine the location of the carriers. A memory 203 stores channel structure formats 203a, which, by way of example, are DRC channel formats; the channel structure formats 203a can also be referred to as report formats. DRC channels are, in an exemplary embodiment, used by the AT 101 of the system 100 to indicate to the AN 105 the selected serving sector as well as the requested data rate on a forward traffic channel. In addition, the memory 203 can include system configuration parameters 203b that specify various characteristics of the multi-carrier system 100.

A selection logic 205 operates in conjunction with the processor 201 to select the appropriate format 203a from memory 203 based on either the correlation of the carriers or the spectral locations of the carriers as determined by the processor 201. An encoder 207 is also provided to code the corresponding DRC reports having the selected formats 203a.

According to various embodiments of the invention, the different formats of DRC channel are selected based on the configuration of the Nx DO system and correlation among the N 1x carriers to maximize the forward link benefits of channel sensitive scheduling, while minimizing the reverse link overhead. Multiple formats 203a of DRC channel that carries DRC information for N carriers are thus defined. It is contemplated that other channel state information can be utilized, such as channel quality information (e.g., Carrier to Interference (C/I) ratio of the channel).

As an exemplary format for the case in which three carriers are independent (for a 3x DO system), Format A (full report format) reports three full DRC values, which utilize 12 bits. These three DRC values, in an exemplary embodiment, are encoded together by the encoder 207 to achieve higher coding gain and better error protection than the case of separate DRC channels for three carriers.

As an exemplary format for the case in which three carriers are highly correlated, Format B (differential report format) reports DRC2, ΔDRC1=(DRCL−DRC2), and ΔDRC3=(DRC3−DRC2). For DO systems, DRC2 can assume value {0x0, 0x1, . . . , 0xe}. For example, letting ΔDRC1 and ΔDRC3 both take values from {−1, 0, +1}, the total combinations of DRC2, ΔDRC1, and ΔDRC3 provide for 125 cases or scenarios. Accordingly, 7 bits are sufficient for Format B. However, it is recognized that additional formats can be defined as necessary based on the particular implementation. The format selection process is further detailed below.

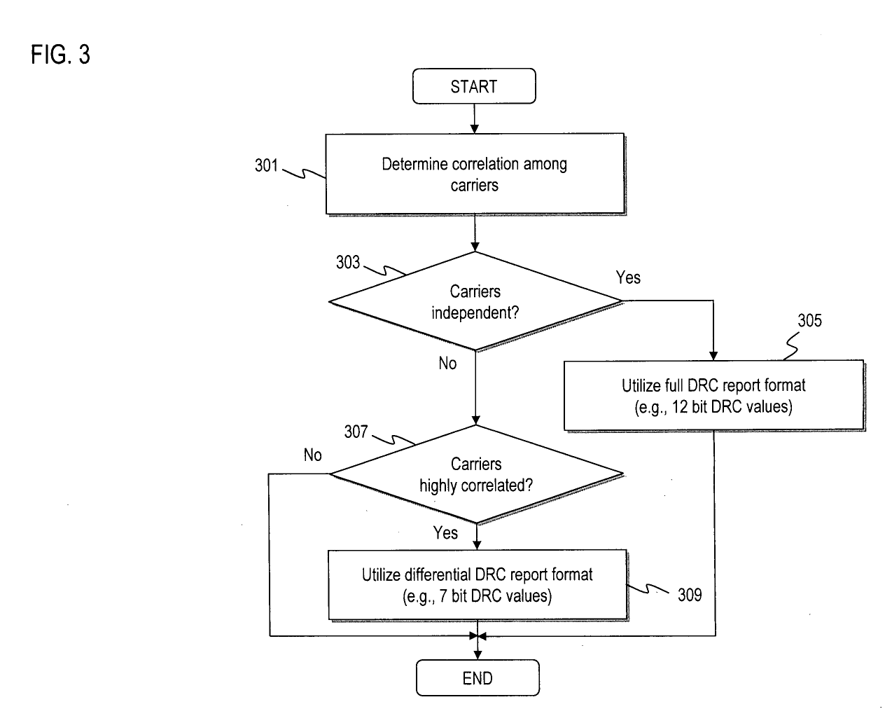

FIG. 3 is a flowchart of a process for determining report format based on correlation of multiple carriers, in accordance with an embodiment of the invention. In step 301, the correlation logic 201a determines the correlation among the carriers. In an exemplary embodiment, the correlation (in a three carrier system) can be determined by the following correlation matrix:

$$R = [ \begin{matrix}{R}_{11} & {R}_{12} & {R}_{13} \\ {R}_{21} & {R}_{22} & {R}_{23} \\ {R}_{31} & {R}_{32} & {R}_{33}\end{matrix} ] ,$$

where Rᵢⱼ represents the correlation between carrier i and carrier j, with Rᵢᵢ=1.0, Rᵢⱼ=R*ⱼᵢ, ∀i,j. After the AT 101 measures the correlation among the three carriers, the AT 101 can determine the format of the DRC channel based on the correlation.

Per step 303, the processor 201 next determines whether the carriers are independent. If the carriers are independent, then the selection logic 205 selects the full report format, as in step 305. Otherwise, it is determined whether the carriers are highly correlated, per step 307; if so, the differential report format is selected (step 309).

The AT 101 and the AN 105 may communicate the choice of the DRC channel format via signaling messages. In an alternative embodiment, the format of the DRC channel can be determined based on the spectral location of the carriers, as next described.

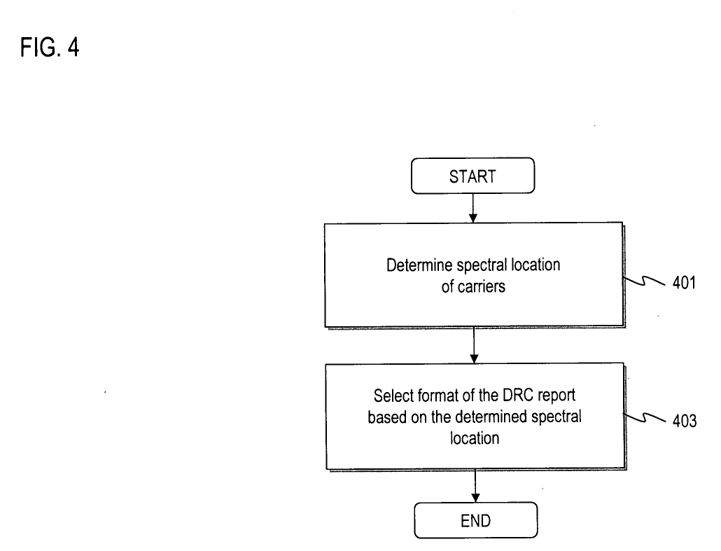

FIG. 4 is a flowchart of a process for determining report format based on spectral location of the carriers, in accordance with an embodiment of the invention. In step 401, the spectral location logic 201b determines the spectral location of the carriers. This location information is then used to select the appropriate format, as in step 403. For example, if the three carriers are within a predetermined band (e.g., a 5 MHz band), such spectral information about the carriers suggests that they are highly correlated; thus, Format B (e.g., differential DRC report) is selected. Otherwise, Format A (e.g., full DRC report) is selected.

With respect to backward compatibility, the Data Rate Control Channel can be transmitted in the reverse link. Thus, the system of FIG. 1 is backward compatible in the sense that an AT that uses this DRC channel structure can coexist with legacy mobiles in the same system.

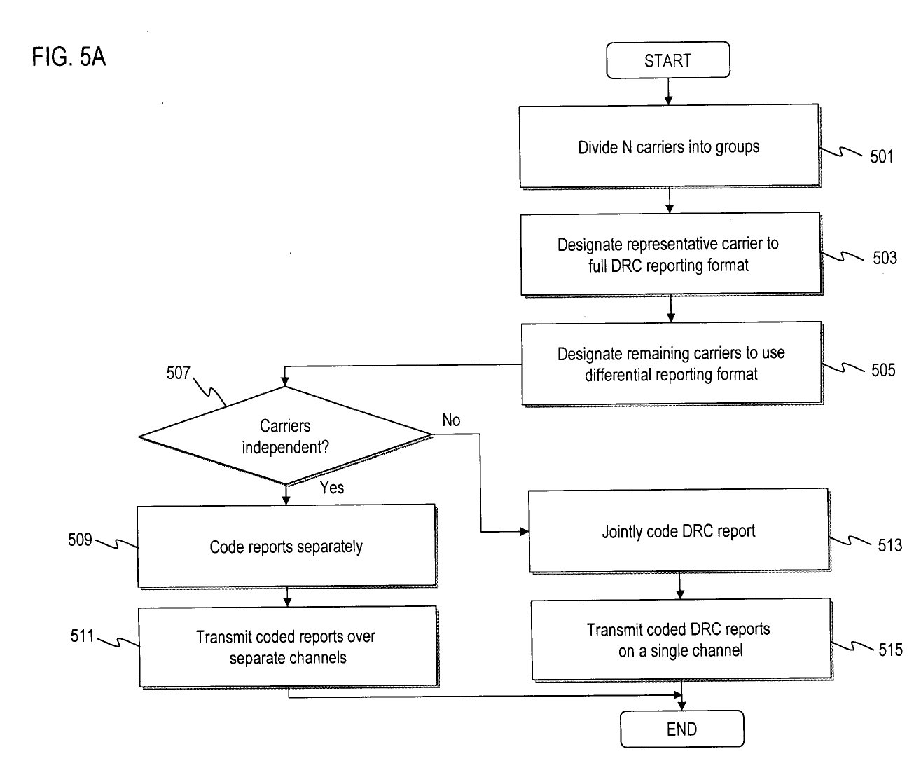

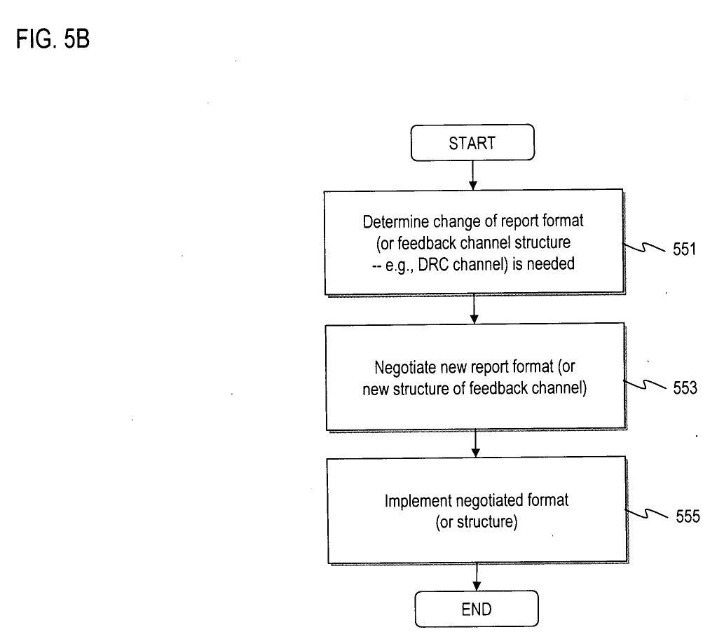

FIGS. 5A and 5B are flowcharts, respectively, of a process for coding reports relating to channel state information, and a process for negotiating a new report format (or structure of a feedback channel), according to various embodiments of the invention. Although some embodiments of the invention are explained with respect to a three carrier system, it is recognized that these various embodiments can be readily extended to an N carrier system. For example, the carriers can be divided into a number of groups (as in step 501), each of which contains several carriers. In each group, one representative carrier is chosen to report the full DRC (step 503), and all other carriers in the group reports the difference of their DRCs relative to the DRC of the representative carrier, per step 505.

In step 507, it is determined whether the carriers are independent. If they are independent, the DRC report of these groups may be coded separately, and transmitted as separate channels, e.g., using CDM, TDM, Orthogonal Frequency Division Multiplexing (OFDM), or other multiplexing techniques (as in steps 509 and 511). Otherwise, according to one embodiment of the invention, the DRC reports can also be jointly coded and transmitted (per steps 513 and 513) as a single channel to maximize the coding and diversity gain.

It is noted that the structure of the feedback channel (e.g., DRC channel) or the report format may change during the course of communication, as illustrated in FIG. 5B. Whenever the AN 105 or the AT 101 determines, as in step 551, that it is appropriate to change the structure of the DRC channel (or the report format), the AN 105 or the AT 101 may negotiate the new structure of DRC channel (or the report format) via signaling messages, per step 553. The newly negotiated structure is then implemented, as in step 555. Because the change can be slow, the overhead due to the signaling is negligible. For example, the following situations may trigger a request to change DRC channel structure: (1) carrier assignment/de-assignment, (2) change in group arrangement, and (3) change in correlation among carriers in the same group.

The invention, according to the various embodiments, exploits the correlation among multiple carriers to reduce the overhead in channel state information feedback. The following generalization can be readily made. For example, cdma2000 HRPD system is used as an exemplary system, but the various embodiments of the invention are applicable to other systems that use multiple carriers—such as multi-carrier CDMA, OFDM-CDMA, OFDM systems, etc. Also, Data Rate Control channel is used as an exemplary channel for channel state information; however, it is contemplated that other type of channel state information report such as carrier to interference ratio (C/I) (or other channel quality information) can be utilized.

One of ordinary skill in the art would recognize that the processes for providing data rate control and/or channel quality signaling may be implemented via software, hardware (e.g., general processor, Digital Signal Processing (DSP) chip, an Application Specific Integrated Circuit (ASIC), Field Programmable Gate Arrays (FPGAs), etc.), firmware, or a combination thereof. Such exemplary hardware for performing the described functions is detailed below.

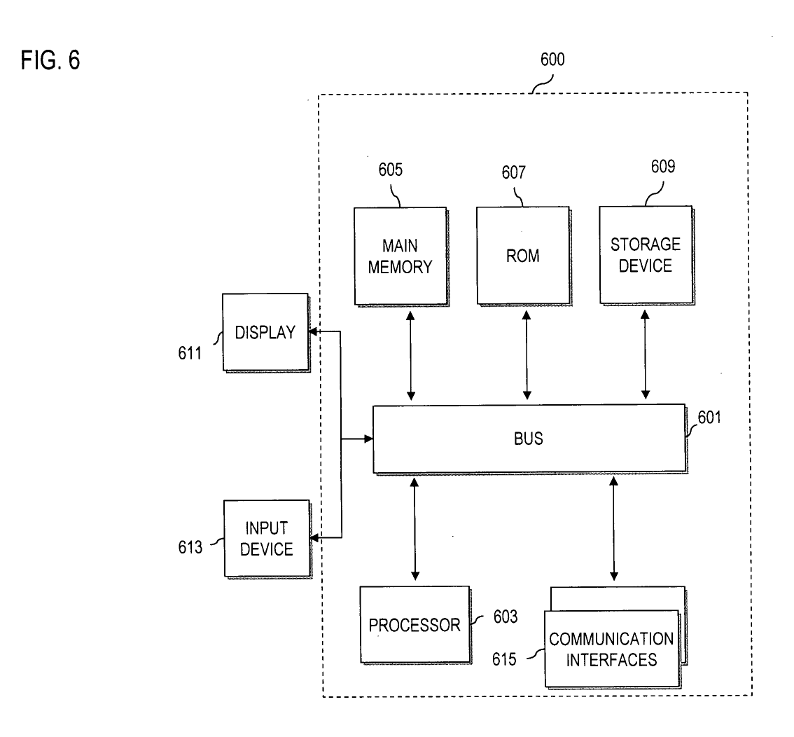

FIG. 6 illustrates exemplary hardware upon which various embodiments of the invention can be implemented. A computing system 600 includes a bus 601 or other communication mechanism for communicating information and a processor 603 coupled to the bus 601 for processing information. The computing system 600 also includes main memory 605, such as a random access memory (RAM) or other dynamic storage device, coupled to the bus 601 for storing information and instructions to be executed by the processor 603. Main memory 605 can also be used for storing temporary variables or other intermediate information during execution of instructions by the processor 603. The computing system 600 may further include a read only memory (ROM) 607 or other static storage device coupled to the bus 601 for storing static information and instructions for the processor 603. A storage device 609, such as a magnetic disk or optical disk, is coupled to the bus 601 for persistently storing information and instructions.

The computing system 600 may be coupled via the bus 601 to a display 611, such as a liquid crystal display, or active matrix display, for displaying information to a user. An input device 613, such as a keyboard including alphanumeric and other keys, may be coupled to the bus 601 for communicating information and command selections to the processor 603. The input device 613 can include a cursor control, such as a mouse, a trackball, or cursor direction keys, for communicating direction information and command selections to the processor 603 and for controlling cursor movement on the display 611.

According to various embodiments of the invention, the processes described herein can be provided by the computing system 600 in response to the processor 603 executing an arrangement of instructions contained in main memory 605. Such instructions can be read into main memory 605 from another computer-readable medium, such as the storage device 609. Execution of the arrangement of instructions contained in main memory 605 causes the processor 603 to perform the process steps described herein. One or more processors in a multi-processing arrangement may also be employed to execute the instructions contained in main memory 605. In alternative embodiments, hard-wired circuitry may be used in place of or in combination with software instructions to implement the embodiment of the invention. In another example, reconfigurable hardware such as Field Programmable Gate Arrays (FPGAs) can be used, in which the functionality and connection topology of its logic gates are customizable at run-time, typically by programming memory look up tables. Thus, embodiments of the invention are not limited to any specific combination of hardware circuitry and software.

The computing system 600 also includes at least one communication interface 615 coupled to bus 601. The communication interface 615 provides a two-way data communication coupling to a network link (not shown). The communication interface 615 sends and receives electrical, electromagnetic, or optical signals that carry digital data streams representing various types of information. Further, the communication interface 615 can include peripheral interface devices, such as a Universal Serial Bus (USB) interface, a PCMCIA (Personal Computer Memory Card International Association) interface, etc.

The processor 603 may execute the transmitted code while being received and/or store the code in the storage device 609, or other non-volatile storage for later execution. In this manner, the computing system 600 may obtain application code in the form of a carrier wave.

The term “computer-readable medium” as used herein refers to any medium that participates in providing instructions to the processor 603 for execution. Such a medium may take many forms, including but not limited to non-volatile media, volatile media, and transmission media. Non-volatile media include, for example, optical or magnetic disks, such as the storage device 609. Volatile media include dynamic memory, such as main memory 605. Transmission media include coaxial cables, copper wire and fiber optics, including the wires that comprise the bus 601. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the invention may initially be borne on a magnetic disk of a remote computer. In such a scenario, the remote computer loads the instructions into main memory and sends the instructions over a telephone line using a modem. A modem of a local system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

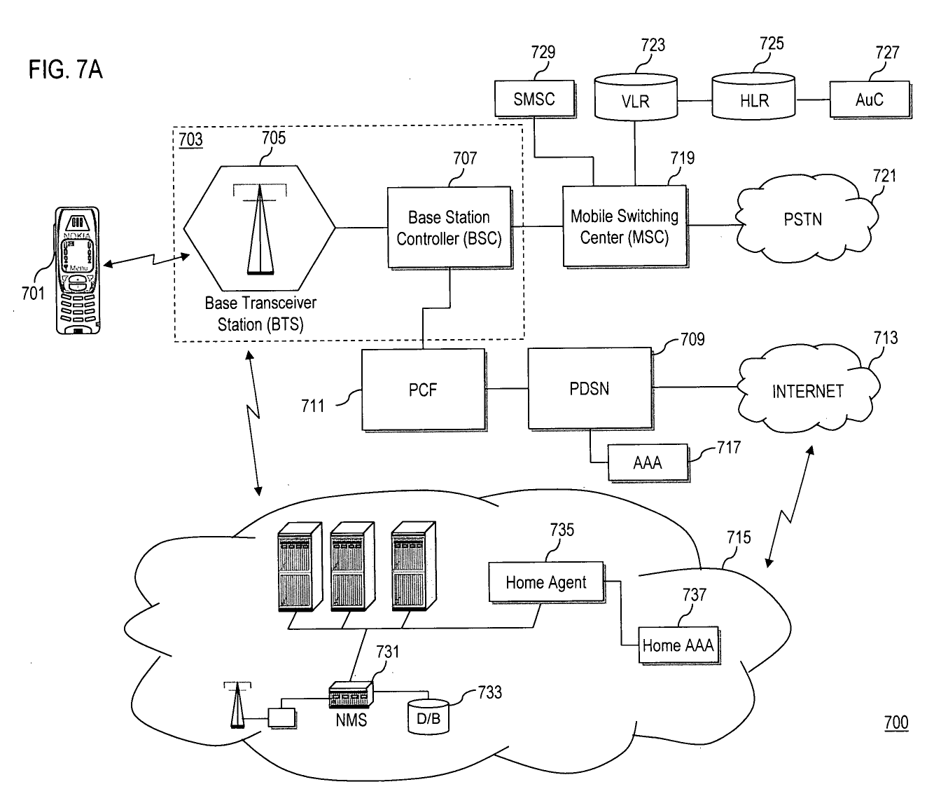

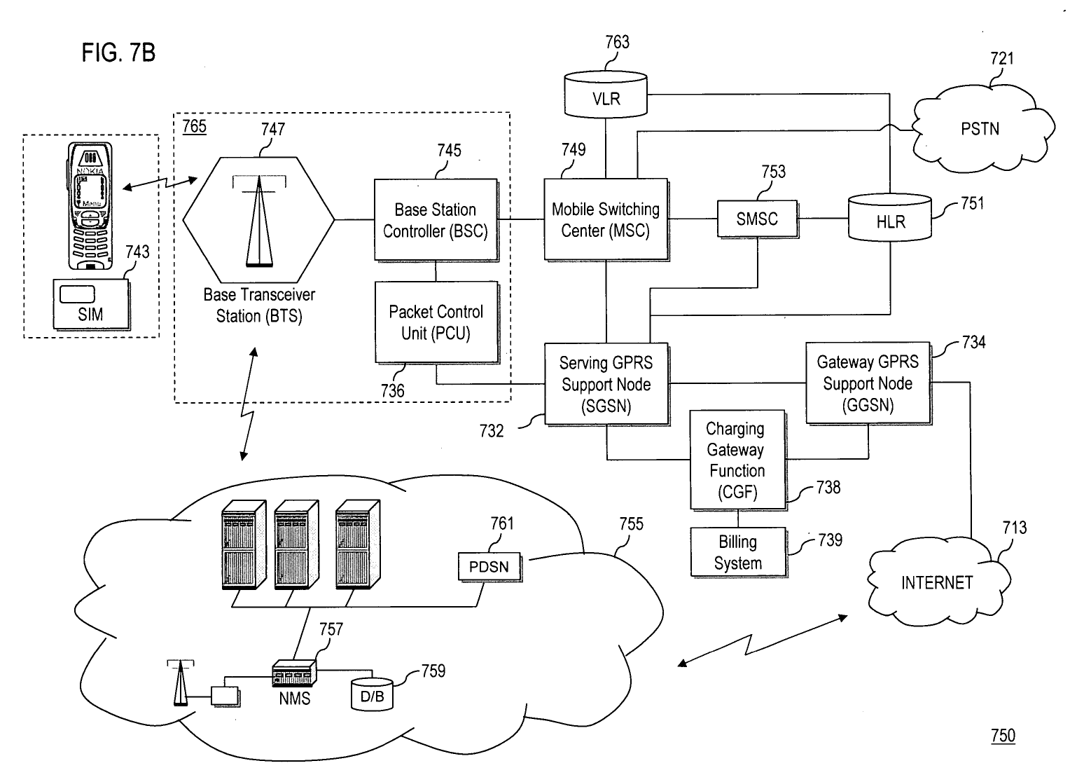

FIGS. 7A and 7B are diagrams of different cellular mobile phone systems capable of supporting various embodiments of the invention. FIGS. 7A and 7B show exemplary cellular mobile phone systems each with both mobile station (e.g., handset) and base station having a transceiver installed (as part of a Digital Signal Processor (DSP)), hardware, software, an integrated circuit, and/or a semiconductor device in the base station and mobile station). By way of example, the radio network supports Second and Third Generation (2G and 3G) services as defined by the International Telecommunications Union (ITU) for International Mobile Telecommunications 2000 (IMT-2000). For the purposes of explanation, the carrier and channel selection capability of the radio network is explained with respect to a cdma2000 architecture. As the third-generation version of IS-95, cdma2000 is being standardized in the Third Generation Partnership Project 2 (3GPP2).

A radio network 700 includes mobile stations 701 (e.g., handsets, terminals, stations, units, devices, or any type of interface to the user (such as “wearable” circuitry, etc.)) in communication with a Base Station Subsystem (BSS) 703. According to one embodiment of the invention, the radio network supports Third Generation (3G) services as defined by the International Telecommunications Union (ITU) for International Mobile Telecommunications 2000 (IMT-2000).

In this example, the BSS 703 includes a Base Transceiver Station (BTS) 705 and Base Station Controller (BSC) 707. Although a single BTS is shown, it is recognized that multiple BTSs are typically connected to the BSC through, for example, point-to-point links. Each BSS 703 is linked to a Packet Data Serving Node (PDSN) 709 through a transmission control entity, or a Packet Control Function (PCF) 711. Since the PDSN 709 serves as a gateway to external networks, e.g., the Internet 713 or other private consumer networks 715, the PDSN 709 can include an Access, Authorization and Accounting system (AAA) 717 to securely determine the identity and privileges of a user and to track each user's activities. The network 715 comprises a Network Management System (NMS) 731 linked to one or more databases 733 that are accessed through a Home Agent (HA) 735 secured by a Home AAA 737.

Although a single BSS 703 is shown, it is recognized that multiple BSSs 703 are typically connected to a Mobile Switching Center (MSC) 719. The MSC 719 provides connectivity to a circuit-switched telephone network, such as the Public Switched Telephone, Network (PSTN) 721. Similarly, it is also recognized that the MSC 719 may be connected to other MSCs 719 on the same network 700 and/or to other radio networks. The MSC 719 is generally collocated with a Visitor Location Register (VLR) 723 database that holds temporary information about active subscribers to that MSC 719. The data within the VLR 723 database is to a large extent a copy of the Home Location Register (HLR) 725 database, which stores detailed subscriber service subscription information. In some implementations, the HLR 725 and VLR 723 are the same physical database; however, the HLR 725 can be located at a remote location accessed through, for example, a Signaling System Number 7 (SS7) network. An Authentication Center (AuC) 727 containing subscriber-specific authentication data, such as a secret authentication key, is associated with the HLR 725 for authenticating users. Furthermore, the MSC 719 is connected to a Short Message Service Center (SMSC) 729 that stores and forwards short messages to and from the radio network 700.

During typical operation of the cellular telephone system, BTSs 705 receive and demodulate sets of reverse-link signals from sets of mobile units 701 conducting telephone calls or other communications. Each reverse-link signal received by a given BTS 705 is processed within that station. The resulting data is forwarded to the BSC 707. The BSC 707 provides call resource allocation and mobility management functionality including the orchestration of soft handoffs between BTSs 705. The BSC 707 also routes the received data to the MSC 719, which in turn provides additional routing and/or switching for interface with the PSTN 721. The MSC 719 is also responsible for call setup, call termination, management of inter-MSC handover and supplementary services, and collecting, charging and accounting information. Similarly, the radio network 700 sends forward-link messages. The PSTN 721 interfaces with the MSC 719. The MSC 719 additionally interfaces with the BSC 707, which in turn communicates with the BTSs 705, which modulate and transmit sets of forward-link signals to the sets of mobile units 701.

As shown in FIG. 7B, the two key elements of the General Packet Radio Service (GPRS) infrastructure 750 are the Serving GPRS Supporting Node (SGSN) 732 and the Gateway GPRS Support Node (GGSN) 734. In addition, the GPRS infrastructure includes a Packet Control Unit PCU (1336) and a Charging Gateway Function (CGF) 738 linked to a Billing System 739. A GPRS the Mobile Station (MS) 741 employs a Subscriber Identity Module (SIM) 743.

The PCU 736 is a logical network element responsible for GPRS-related functions such as air interface access control, packet scheduling on the air interface, and packet assembly and re-assembly. Generally the PCU 736 is physically integrated with the BSC 745; however, it can be collocated with a BTS 747 or a SGSN 732. The SGSN 732 provides equivalent functions as the MSC 749 including mobility management, security, and access control functions but in the packet-switched domain. Furthermore, the SGSN 732 has connectivity with the PCU 736 through, for example, a Fame Relay-based interface using the BSS GPRS protocol (BSSGP). Although only one SGSN is shown, it is recognized that that multiple SGSNs 731 can be employed and can divide the service area into corresponding routing areas (RAs). A SGSN/SGSN interface allows packet tunneling from old SGSNs to new SGSNs when an RA update takes place during an ongoing Personal Development Planning (PDP) context. While a given SGSN may serve multiple BSCs 745, any given BSC 745 generally interfaces with one SGSN 732. Also, the SGSN 732 is optionally connected with the HLR 751 through an SS7-based interface using GPRS enhanced Mobile Application Part (MAP) or with the MSC 749 through an SS7-based interface using Signaling Connection Control Part (SCCP). The SGSN/HLR interface allows the SGSN 732 to provide location updates to the HLR 751 and to retrieve GPRS-related subscription information within the SGSN service area. The SGSN/MSC interface enables coordination between circuit-switched services and packet data services such as paging a subscriber for a voice call. Finally, the SGSN 732 interfaces with a SMSC 753 to enable short messaging functionality over the network 750.

The GGSN 734 is the gateway to external packet data networks, such as the Internet 713 or other private customer networks 755. The network 755 comprises a Network Management System (NMS) 757 linked to one or more databases 759 accessed through a PDSN 761. The GGSN 734 assigns Internet Protocol (IP) addresses and can also authenticate users acting as a Remote Authentication Dial-In User Service host. Firewalls located at the GGSN 734 also perform a firewall function to restrict unauthorized traffic. Although only one GGSN 734 is shown, it is recognized that a given SGSN 732 may interface with one or more GGSNs 733 to allow user data to be tunneled between the two entities as well as to and from the network 750. When external data networks initialize sessions over the GPRS network 750, the GGSN 734 queries the HLR 751 for the SGSN 732 currently serving a MS 741.

The BTS 747 and BSC 745 manage the radio interface, including controlling which Mobile Station (MS) 741 has access to the radio channel at what time. These elements essentially relay messages between the MS 741 and SGSN 732. The SGSN 732 manages communications with an MS 741, sending and receiving data and keeping track of its location. The SGSN 732 also registers the MS 741, authenticates the MS 741, and encrypts data sent to the MS 741.

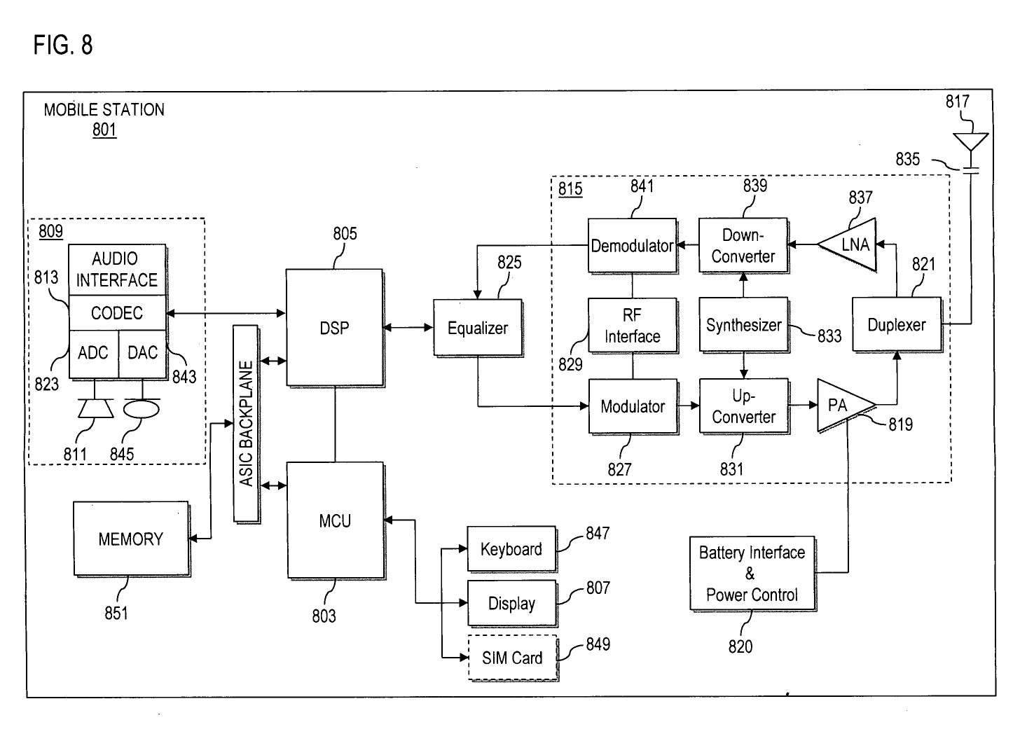

FIG. 8 is a diagram of exemplary components of a mobile station (e.g., handset) capable of operating in the systems of FIGS. 7A and 7B, according to an embodiment of the invention. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile station functions. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system (e.g., systems of FIG. 7A or 7B), via antenna 817. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile station 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In the exemplary embodiment, the processed voice signals are encoded, by units not separately shown, using the cellular transmission protocol of Code Division Multiple Access (CDMA), as described in detail in the Telecommunication Industry Association's TIA/EIA/IS-95-A Mobile Station-Base Station Compatibility Standard for Dual-Mode Wideband Spread Spectrum Cellular System; which is incorporated herein by reference in its entirety.

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 1005. A Digital to Analog Converter (DAC) 843 converts the signal and the resulting output is transmitted to the user through the speaker 845, all under control of a Main Control Unit (MCU) 803—which can be implemented as a Central Processing Unit (CPU) (not shown).

The MCU 803 receives various signals including input signals from the keyboard 847. The MCU 803 delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the station. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile station 801.

The CODEC 813 includes the ADC 823 and DAC 843. The memory 851 stores various data including call incoming tone data and is capable of storing other data including music data received via, e.g., the global Internet. The software module could reside in RAM memory, flash memory, registers, or any other form of writable storage medium known in the art. The memory device 851 may be, but not limited to, a single memory, CD, DVD, ROM, RAM, EEPROM, optical storage, or any other non-volatile storage medium capable of storing digital data.

An optionally incorporated SIM card 849 carries, for instance, important information, such as the cellular phone number, the carrier supplying service, subscription details, and security information. The SIM card 849 serves primarily to identify the mobile station 801 on a radio network. The card 849 also contains a memory for storing a personal telephone number registry, text messages, and user specific mobile station settings.

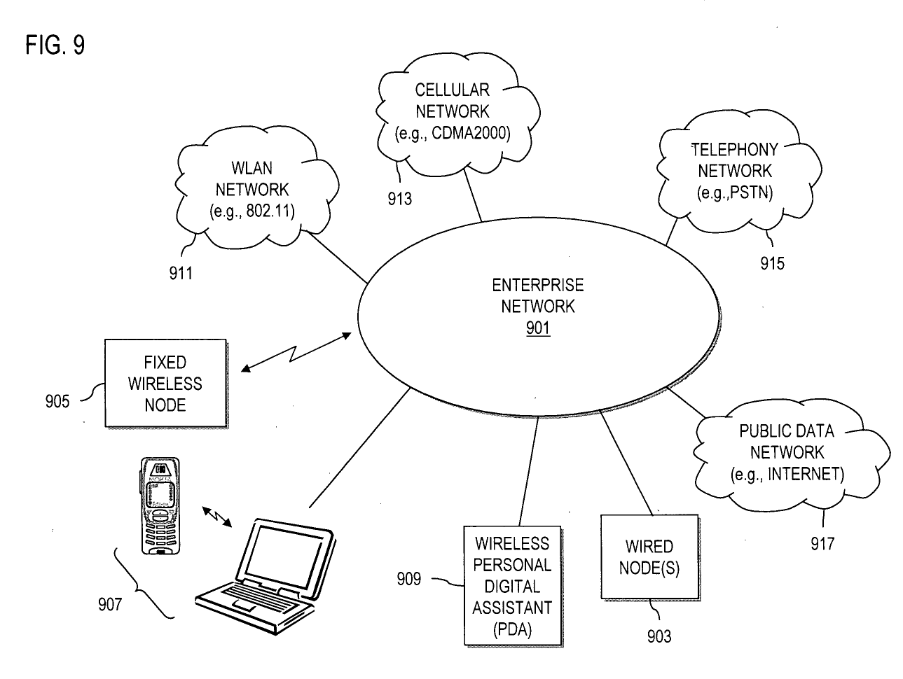

FIG. 9 shows an exemplary enterprise network, which can be any type of data communication network utilizing packet-based and/or cell-based technologies (e.g., Asynchronous Transfer Mode (ATM), Ethernet, IP-based, etc.). The enterprise network 901 provides connectivity for wired nodes 903 as well as wireless nodes 905-909 (fixed or mobile), which are each configured to perform the processes described above. The enterprise network 901 can communicate with a variety of other networks, such as a WLAN network 911 (e.g., IEEE 802.11), a cdma2000 cellular network 913, a telephony network 916 (e.g., PSTN), or a public data network 917 (e.g., Internet).

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
determining either spectral locations of a first carrier and a second carrier, or correlation between the first carrier and the second carrier; and
selecting a report format among a plurality of report formats based on either the determined correlation or spectral locations,
wherein each of the report formats specifies channel state information for the first carrier and the second carrier, the channel state information including data rate information.

2. A method according to claim 1, wherein the first carrier and the second carrier are associated with a forward link, and the selected report format corresponds to a reverse link.

3. A method according to claim 1, wherein the selection of the report format is further based on a configuration parameter of a multi-carrier data network configured to provide the first carrier and the second carrier.

4. A method according to claim 1, wherein the report format includes one of a full report format or a differential report format.

5. A method according to claim 1, wherein the first carrier and the second carrier are associated with one of a plurality of groups, the method further comprising:
designating the first carrier as a representative carrier for the one group, wherein the selected report format for the representative carrier is a full report format and a report format of the second carrier is a differential report format.

6. A method according to claim 5, further comprising:
separately encoding reports corresponding to the report formats of the first carrier and the second carrier; and
transmitting the separately encoded reports over respective separate channels.

7. A method according to claim 5, further comprising:
jointly encoding reports corresponding to the report formats of the first carrier and the second carrier; and
transmitting the jointly encoded reports over a single channel.

8. A method according to claim 5, further comprising:
negotiating a change of the selected report format during a communication session supported by the first carrier and the second carrier.

9. A method according to claim 8, wherein the negotiation is initiated by either an assignment of one of the carriers, a de-assignment of one of the carriers, a change in group arrangement of the carriers, or a change in correlation of the carriers of a common group.

10. A method according to claim 1, wherein the channel state information includes data rate information of the carriers or channel quality information.

11. An apparatus comprising:
a processor configured to determine either spectral locations of a first carrier and a second carrier, or correlation between the first carrier and the second carrier; and
selection logic configured to select a report format among a plurality of report formats based on either the determined correlation or spectral locations,
wherein each of the report formats specifies channel state information for the first carrier and the second carrier, the channel state information including data rate information.

12. An apparatus according to claim 11, wherein the first carrier and the second carrier are associated with a forward link, and the selected report format corresponds to a reverse link.

13. An apparatus according to claim 11, wherein the selection of the report format is further based on a configuration parameter of a multi-carrier data network configured to provide the first carrier and the second carrier.

14. An apparatus according to claim 11, wherein the report format includes one of a full report format or a differential report format.

15. An apparatus according to claim 11, wherein the first carrier and the second carrier are associated with one of a plurality of groups, the processor being further configured to designate the first carrier as a representative carrier for the one group, wherein the selected report format for the representative carrier is a full report format and a report format of the second carrier is a differential report format.

16. An apparatus according to claim 15, further comprising:
an encoder configured to separately encode reports corresponding to the report formats of the first carrier and the second carrier, wherein the separately encoded reports are transmitted over respective separate channels.

17. An apparatus according to claim 15, further comprising:
an encoder configured to jointly encode reports corresponding to the report formats of the first carrier and the second carrier, wherein the jointly encoded reports are transmitted over a single channel.

18. An apparatus according to claim 15, wherein the processor is further configured to negotiate a change of the selected report format during a communication session supported by the first carrier and the second carrier.

19. An apparatus according to claim 18, wherein the negotiation is initiated by either an assignment of one of the carriers, a de-assignment of one of the carriers, a change in group arrangement of the carriers, or a change in correlation of the carriers of a common group.

20. An apparatus according to claim 11, wherein the channel state information includes data rate information of the carriers or channel quality information.

21. A system comprising the apparatus of claim 11, the system further comprising:
means for receiving user input to initiate communication over the carriers; and
a display configured to display the user input.

22. A system comprising:
a base station configured to communicate over a first link comprising a plurality of carriers; and
a terminal configured to communicate with the base station over the first link and a second link, wherein the terminal is further configured to determine either spectral locations of the carriers or correlation between the carriers, the terminal being further configured to select one of a plurality of report channel formats corresponding to the second link based on either the spectral locations or the correlation,
wherein each of the report channel formats specifies channel state information including data rate information for the carriers.

23. A system according to claim 22, wherein the first link is a forward link and the second link is a reverse link, the selection of the report format being further based on a configuration parameter of a multi-carrier data network configured to provide the carriers, wherein the report format includes one of a full report format or a differential report format.

24. A system according to claim 22, wherein the carriers provide an overlay data network onto a single carrier network.
